(19) United States
(12) Patent Application Publication
(10) Pub. No.: US 2025/0372868 A1
(43) Pub. Date: Dec. 4, 2025

(54) FEED NETWORK AND ANTENNA DEVICE

(71) Applicant: HUAWEI TECHNOLOGIES CO., LTD., Shenzhen (CN)

(72) Inventors: Xinming Liu, Xi'an (CN); Peifeng Hu, Xi'an (CN); Jiaxu Li, Xi'an (CN); Weihong Xiao, Dongguan (CN)

(73) Assignee: HUAWEI TECHNOLOGIES CO., LTD., Shenzhen (CN)

(21) Appl. No.: 19/301,163

(22) Filed: Aug. 15, 2025

Related U.S. Application Data
(63) Continuation of application No. PCT/CN2023/136232, filed on Dec. 4, 2023.

(30) Foreign Application Priority Data
Feb. 17, 2023 (CN) 202310175288.5

(51) Int. Cl. H01Q 3/12; H01Q 1/24; H01Q 1/28; H01Q 3/26

(52) U.S. Cl. CPC H01Q 3/12; H01Q 1/246; H01Q 1/288; H01Q 3/267

(57) ABSTRACT

This application discloses a feed network and an antenna device, and relates to the field of communication technologies, to implement a three-dimensional layout of the feed network, and facilitate miniaturization development of the feed network. The feed network includes a support frame and a signal transmission circuit deployed on the support frame. The signal transmission circuit includes a plurality of interconnected functional units, and the plurality of functional units are not located on a same plane.

### CROSS-REFERENCE TO RELATED APPLICATIONS

This application is a continuation of International Application No. PCT/CN2023/136232, filed on Dec. 4, 2023, which claims priority to Chinese Patent Application No. 202310175288.5, filed on Feb. 17, 2023. The disclosures of the aforementioned applications are hereby incorporated by reference in their entireties.

### TECHNICAL FIELD

This application relates to the field of communication technologies, and in particular, to a feed network and an antenna device.

### BACKGROUND

A highly integrated miniaturization design is one of main development directions of most current antenna devices (for example, a base station antenna, a vehicle-mounted antenna, and a satellite antenna). A feed network is an important structure used for signal transmission between an antenna array and a signal processing unit in the antenna device, and a size of the feed network directly affects a size of the antenna device. Therefore, implementing a miniaturization design also becomes one of important evolution directions of the feed network.

Currently, the feed network is usually deployed on a circuit board or a metal plate, and is disposed in internal space of the antenna device with a corresponding antenna array. With gradual improvement of signal transmission performance of the antenna device, an increasing number of radiating elements are integrated in the antenna array. Consequently, a design of a corresponding feed network is increasingly complex, and an area of the circuit board needs to be increased to deploy the feed network. Therefore, this deployment manner of performing a planar layout via the circuit board can hardly meet a miniaturization development requirement of the feed network.

### SUMMARY

Embodiments of this application provide a feed network and an antenna device, to implement a three-dimensional layout of the feed network, improve space utilization, and facilitate miniaturization development of the feed network.

To achieve the foregoing objective, the following technical solutions are used in embodiments of this application.

According to a first aspect, an embodiment of this application provides a feed network, including a support frame and a signal transmission circuit deployed on the support frame. The signal transmission circuit includes a plurality of interconnected functional units, and the plurality of functional units are not located on a same plane.

In the feed network provided in this embodiment of this application, the signal transmission circuit is deployed on the support frame, so that the plurality of functional units in the signal transmission circuit are not located on the same plane. In other words, the signal transmission circuit implements a three-dimensional layout via the support frame. For signal transmission circuits with same complexity, compared with a planar layout manner on a circuit board or a metal plate, the three-dimensional layout manner makes a structure of the feed network compact, improves space utilization, and facilitates miniaturization development of the feed network.

In an embodiment, the plurality of functional units are respectively deployed on a plurality of surfaces of the support frame, and the plurality of surfaces are not coplanar.

In an embodiment, the plurality of surfaces include a curved surface and/or a plane.

In an embodiment, the support frame is of a hollow structure, and the plurality of surfaces include an inner surface and/or an outer surface of the support frame.

In an embodiment, the plurality of surfaces include at least two curved surfaces with different curvatures.

In an embodiment, the plurality of functional units include a first functional unit, and the first functional unit is deployed on different surfaces in the plurality of surfaces.

In an embodiment, the plurality of functional units are connected via a transmission line, and the transmission line is deployed on the support frame.

In an embodiment, the plurality of functional units are connected via a connector, and the connector is deployed on the support frame.

In an embodiment, the signal transmission circuit is deployed on one curved surface of the support frame.

In an embodiment, the plurality of functional units further include a phase shift circuit, the feed network further includes a phase shift medium, the phase shift medium covers the support frame, and the phase shift medium is capable of moving relative to the support frame under control of the phase shift circuit.

In an embodiment, the support frame includes a peripheral frame and a movable member, the movable member is located in a cavity of the peripheral frame, and the movable member is capable of moving in the cavity. The plurality of functional units include a first transmission unit and a second transmission unit, and the first transmission unit is deployed on an inner surface and/or an outer surface of the peripheral frame. The second transmission unit is disposed on a surface of the movable member.

In an embodiment, the feed network further includes a plurality of connection ports, the plurality of connection ports are configured to separately connect the signal transmission circuit to a radiating element and a signal processing unit, the plurality of connection ports are deployed on the support frame, and the plurality of connection ports are not located on a same plane or are located on a same plane.

According to a second aspect, an embodiment of this application provides an antenna device, including the feed network according to any manner of the first aspect. In an embodiment, the antenna device is a base station antenna.

In an embodiment, the antenna device may alternatively be a vehicle-mounted antenna, a satellite antenna, or another communication device having a radio frequency function.

It may be understood that for beneficial effect of the second aspect, refer to the related descriptions in the first aspect. Details are not described herein again.

### BRIEF DESCRIPTION OF DRAWINGS

FIG. 1 is a system block diagram of a base station antenna feeder system according to an embodiment of this application;

FIG. 2 is a diagram of a structure of a base station antenna according to an embodiment of this application;

FIG. 3 (a) and (b) are a diagram 1 of a structure of a feed network according to an embodiment of this application;

FIG. 4 is a diagram 2 of a structure of a feed network according to an embodiment of this application;

FIG. 5 is a diagram 3 of a structure of a feed network according to an embodiment of this application;

FIG. 6 (a) and (b) are a diagram 4 of a structure of a feed network according to an embodiment of this application;

FIG. 7 is a diagram 5 of a structure of a feed network according to an embodiment of this application;

FIG. 8 (a) and (b) are a diagram 6 of a structure of a feed network according to an embodiment of this application;

FIG. 9 is a diagram 7 of a structure of a feed network according to an embodiment of this application;

FIG. 10 is a diagram 8 of a structure of a feed network according to an embodiment of this application;

FIG. 11 is a diagram 9 of a structure of a feed network according to an embodiment of this application;

FIG. 12 is a diagram 10 of a structure of a feed network according to an embodiment of this application;

FIG. 13 is a diagram 11 of a structure of a feed network according to an embodiment of this application;

FIG. 14 (a) and (b) are a diagram 12 of a structure of a feed network according to an embodiment of this application;

FIG. 15 is a diagram 13 of a structure of a feed network according to an embodiment of this application;

FIG. 16 is a diagram 14 of a structure of a feed network according to an embodiment of this application;

FIG. 17 is a diagram 15 of a structure of a feed network according to an embodiment of this application;

FIG. 18 is a diagram 16 of a structure of a feed network according to an embodiment

of this application; and

FIG. 19 is a diagram 17 of a structure of a feed network according to an embodiment of this application.

Reference numerals in the figures are as follows:

1: base station antenna; 2: pole; 3: antenna adjustment support; 4: grounding apparatus; 5: signal processing unit;
1: base station antenna; 11: radome; 12: antenna array; 121: radiating element; 122: reflection plate; 13: feed network; 14: antenna connector;
13: feed network; 131: support frame; 132: signal transmission circuit; 133: connection port; 134: insulation medium; 135: phase shift medium;
131: support frame; 1311: through hole; 1312: peripheral frame; 1313: movable member;
132: signal transmission circuit; 1321: functional unit; 1322: transit network; 13211: first transmission unit; and 13212: second transmission unit.

### DESCRIPTION OF EMBODIMENTS

The feed network provided in this application is applicable to an antenna device having a radio frequency transmission function, for example, a base station antenna, a satellite antenna, or a vehicle-mounted antenna. First, the base station antenna is used as an example to describe an application scenario of the feed network provided in this application.

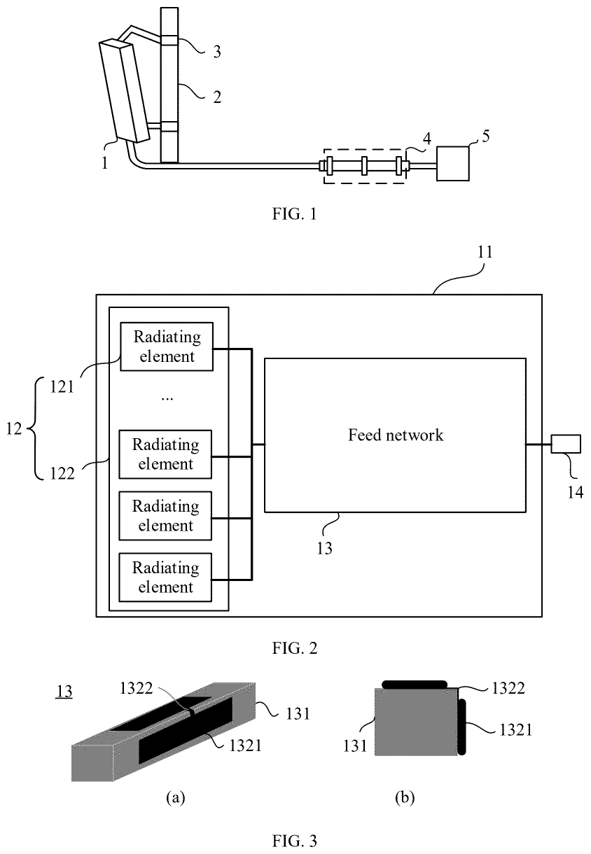

FIG. 1 is a diagram of a structure of a base station antenna feeder system according to an embodiment of this application. The system includes a base station antenna 1, a pole 2, an antenna adjustment support 3, and a grounding apparatus 4. The base station antenna 1 is connected to the grounding apparatus 4 and a signal processing unit 5 via a feeder, and is configured to radiate, to the outside, a radio frequency signal sent by the signal processing unit 5, or send a received radio wave to the signal processing unit 5. The signal processing unit 5 may be a radio remote unit (RRU) or a radio frequency front-end (RFFE) disposed near the base station antenna feeder system (for example, buried under the pole 2), and is configured to perform conversion between a radio frequency signal and a digital signal, and the data signal obtained through conversion is sent to a baseband processing unit for processing. The baseband processing unit may be a building baseband unit (BBU) corresponding to the RRU, or a baseband processor corresponding to the RFFE.

The antenna adjustment support 3 may adjust a tilt angle of the base station antenna 1 relative to the pole 2, to adjust a radiation range of the base station antenna 1.

FIG. 2 is a diagram of a structure of the base station antenna 1 according to an embodiment of this application. The base station antenna 1 includes a radome 11, at least one independent antenna array 12, and a feed network 13 and an antenna connector 14 that correspond to each antenna array 12. The antenna array 12 usually includes at least one radiating element 121 and a reflection plate 122, and the at least one radiating element 121 is arranged on the reflection plate 122. The radiating element 121 may also be referred to as an antenna element or an element, and a form of the radiating element 121 may be a dipole antenna, may be an antenna form like a monopole antenna, an inverted-F antenna (IFA), a loop antenna, or a T-shaped antenna, or may be another type of antenna like a slot antenna or a patch antenna or a hybrid antenna. The radiating element 121 is configured to receive or radiate a radio wave.

The reflection plate 122 may also be referred to as a bottom plate, an antenna panel, or a metal reflective surface, and can reflect and aggregate a radio wave on a reception point, to improve signal receiving sensitivity of the radiating element 121. In addition to enhancing a receiving capability and a radiation capability of the radiating element 121, another electric wave on the back of the reflection plate 122 can be shielded, to avoid interference of the another electric wave to a received signal.

Each radiating element 121 in the antenna array 12 is connected to the feed network 13, and the feed network 13 is configured to: feed, to each radiating element 121 based on a phase and amplitude, a radio frequency signal sent by the signal processing unit 5, and feed, to the signal processing unit 5 based on a phase and amplitude, a radio frequency signal received by each radiating element 121.

The feed network 13 may include a signal transmission circuit including a transmission line. Alternatively, the feed network 13 is a signal transmission circuit including a transmission line and a functional device. The functional device may include but is not limited to a phase shifter, a power divider, a calibrator, a combiner, a filter, and the like. The phase shifter is configured to adjust a phase of the radiating element 121, to implement electrical downtilt adjustment. The power divider is configured to divide a radio frequency signal received by the feed network 13 into a plurality of groups of radio frequency signals and output the plurality of groups radio frequency signals to the plurality of radiating elements 121. The calibrator is configured to obtain a calibration signal. The combiner is configured to combine signals from the plurality of radiating elements 121 into one path of signal. The filter is configured to filter interference noise in a radio frequency signal. The functional device may be designed based on a requirement of the feed network 13. Details are not described herein again.

A highly integrated design with a smaller size and better transmission performance is one of important development directions of the base station antenna 1. Therefore, a miniaturization design of the feed network 13 also becomes a key research and development direction. Therefore, this application provides a feed network 13 with a three-dimensional layout, which has high space usage, and facilitates miniaturization development of the feed network 13.

The feed network 13 provided in embodiments of this application includes a support frame 131 and a signal transmission circuit 132 deployed on the support frame 131. The signal transmission circuit 132 may include a plurality of interconnected functional units 1321, and the plurality of functional units 1321 are not located on a same plane.

It may be understood that, that the plurality of functional units 1321 are not located on the same plane means that the plurality of functional units 1321 may be located on a plurality of intersecting planes and/or curved surfaces, or located on a same curved surface. An arrangement manner may be implemented by disposing a structure of the support frame 131.

For example, the support frame 131 includes a plurality of surfaces, and the plurality of surfaces are not coplanar. The plurality of surfaces may be all curved surfaces, may be all planes, or some surfaces may be curved surfaces and other surfaces may be planes. The plurality of functional units 1321 may be deployed on the plurality of surfaces of the support frame 131, or deployed on one curved surface of the support frame 131. In other words, the signal transmission circuit 132 may implement the three-dimensional layout via the support frame 131.

In an example, the plurality of functional units 1321 in the signal transmission circuit 132 may be different circuit units obtained through division based on functions. For example, the signal transmission circuit 132 may include a phase shift circuit, a power division circuit, a filter circuit, and the like based on the plurality of functions of the signal transmission circuit 132. When division is performed based on the functions, a functional unit 1321 may be deployed on a same plane or curved surface, or deployed on different planes or curved surfaces. For example, a part of a first functional unit in the plurality of functional units 1321 is deployed on one plane, and the other part is deployed on another plane. This is not limited in this application.

In another example, when the support frame includes the plurality of surfaces (the plurality of surfaces are not coplanar), a circuit unit located on a same surface in the signal transmission circuit 132 may be referred to as one functional unit 1321.

Two interconnected functional units 1321 may be coupled, or may be directly connected over a transit network 1322. In embodiments of this application, the transit network 1322 may be a transmission line. For example, the transmission line may be a transmission line integrated with a transmission line in the functional unit 1321. The transmission line may be a microstrip, a suspended strip line, a coplanar waveguide (CPW), or the like. This is not limited in this application.

In an embodiment, the transit network 1322 may alternatively be connected via an independent connector, for example, a jumper or a coupling connector.

In embodiments of this application, the signal transmission circuit 132 may be deployed on the surface of the support frame 131 through electroplating, or may be deployed on the surface of the support frame 131 through conformal coating, so that the signal transmission circuit 132 presents the structure of the support frame 131 in space. This is not limited in this application.

It may be understood that, for signal transmission circuits 132 with same complexity, compared with a planar layout manner on a circuit board, the three-dimensional layout manner provided in this application can fully use three-dimensional space, makes deployment of the feed network more compact, greatly improves space utilization, and facilitates miniaturization development of the feed network.

With reference to accompanying drawings, the following lists a plurality of structures of the support frame 131 and deployment manners of the plurality of functional units 1321, to describe technical solutions of this application by using examples. Embodiments listed below are merely examples, and are intended to explain the feed network 13 provided in this application, and should not be understood as a limitation on this application.

### EMBODIMENT 1

The support frame 131 is of a solid structure.

In an example, the solid structure may be a polyhedron structure. In one embodiment, the support frame 131 includes a plurality of surfaces, and each surface is a plane. The plurality of functional units 1321 may be deployed on each surface of the support frame 131, or may be deployed on some (at least two) surfaces of the support frame 131.

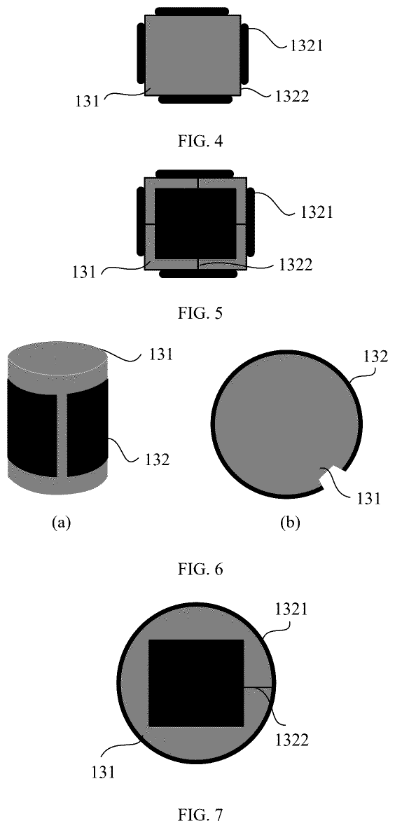

For example, the support frame 131 is a quadrangular prism, and includes six surfaces (namely, two bottom surfaces and four side surfaces). As shown in FIG. 3, the signal transmission circuit 132 may include two functional units 1321, which are respectively deployed on two adjacent side surfaces of the support frame 131, (a) in FIG. 3 is a three-dimensional diagram of the feed network 13, and (b) in FIG. 3 is a side diagram of the feed network 13. Alternatively, in a side diagram shown in FIG. 4, the signal transmission circuit 132 may include four functional units 1321, which are respectively deployed on the four side surfaces of the support frame 131. Alternatively, in a side diagram shown in FIG. 5, the signal transmission circuit 132 may include six functional units 1321, which are respectively deployed on the six surfaces of the support frame 131.

In an example, the solid structure may be a cylinder including at least one curved surface.

For example, the support frame 131 is a cylinder, and includes three surfaces (namely, two bottom surfaces and one side surface). As shown in FIG. 6, the plurality of functional units 1321 of the signal transmission circuit 132 may be all deployed on the side surface of the support frame 131, that is, the signal transmission circuit 132 is deployed on one curved surface as a whole, (a) in FIG. 6 is a three-dimensional diagram of the feed network 13, and (b) in FIG. 6 is a side diagram of the feed network 13. Alternatively, in a side diagram shown in FIG. 7, the signal transmission circuit 132 may include two functional units 1321, which are respectively deployed on a bottom surface and the side surface of the support frame 131.

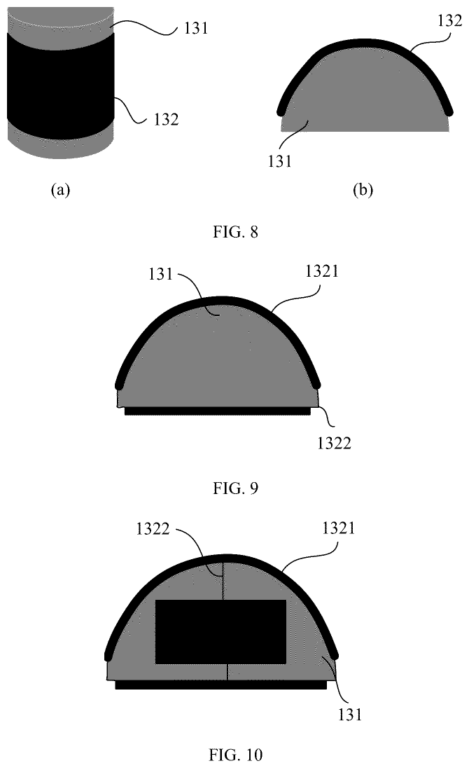

For another example, the support frame 131 may be a semi-cylinder (that is, a cylinder whose bottom surface is a semi-circle), and includes four surfaces (namely, two semi-circular bottom surfaces and two side surfaces, which are respectively one plane and one curved surface). As shown in FIG. 8, the signal transmission circuit 132 may be deployed on the curved surface as a whole, (a) in FIG. 8 is a three-dimensional diagram of the feed network 13, and (b) in FIG. 8 is a side diagram of the feed network 13. Alternatively, as shown in FIG. 9, the signal transmission circuit 132 may include two functional units 1321, which are respectively deployed on the two side surfaces of the cylinder. Alternatively, as shown in FIG. 10, the signal transmission circuit 132 may include four functional units 1321, which are respectively deployed on four surfaces of the support frame 131, namely, the two bottom surfaces and the two side surfaces.

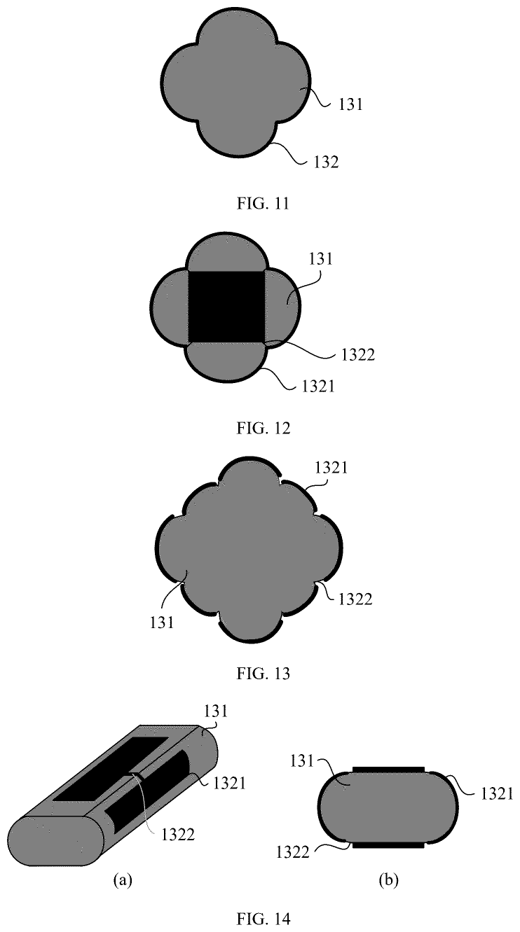

For another example, the support frame 131 may be a cylinder whose side surfaces are all curved surfaces. For example, in a side diagram shown in FIG. 11, the support frame 131 is a cylinder and includes four side surfaces with a same curvature, and the plurality of functional units 1321 of the signal transmission circuit 132 may be respectively deployed on the four curved surfaces. Alternatively, in a side diagram shown in FIG. 12, the plurality of functional units 1321 of the signal transmission circuit 132 may be respectively deployed on the side surfaces and the bottom surface.

For another example, the support frame 131 may alternatively include a plurality of curved surfaces with different curvatures (that is, curvatures of the plurality of curved surfaces are different, or curvatures of some curved surfaces are the same and curvatures of some curved surfaces are different). As shown in FIG. 13, side surfaces of the support frame 131 include eight curved surfaces with different curvatures, and the signal transmission circuit 132 may include eight functional units 1321, which are respectively deployed on the curved surfaces.

For another example, the support frame 131 may be a cylinder shown in FIG. 14, and side surfaces of the support frame 131 include two curved surfaces and two planes, and the plurality of functional units 1321 of the signal transmission circuit 132 are respectively deployed on the four side surfaces of the support frame. (a) in FIG. 14 is a three-dimensional diagram of the feed network 13, and (b) in FIG. 14 is a side diagram of the feed network 13.

The solid structures listed above are merely examples for description, and are not listed one by one herein. It may be understood that the signal transmission circuit 132 is deployed on the support frame 131, so that the signal transmission circuit 132 presents the three-dimensional structure in space, and the layout is compact. This greatly improves space utilization, and facilitates miniaturization development of the feed network 13.

In addition, in an example, for the support frame 131 using the solid structure, because the surfaces of the support frame 131 are interconnected, the signal transmission circuit 132 can be processed and disposed on the plurality of surfaces of the support frame 131 at a time directly through electroplating or coating, thereby greatly reducing jump welding. Therefore, manufacturing efficiency of the feed network 13 and reliability of signal transmission are improved, and manufacturing costs are reduced.

In an example, for the irregular support frame 131, after the signal transmission circuit 132 is deployed on the support frame 131, an insulation medium 133 may be filled outside the support frame 131, to change an external shape of the feed network 13. This makes the external shape of the feed network 13 better adapt to internal space of the base station antenna, and facilitates mounting and fastening of the feed network 13 in the antenna device. In addition, the signal transmission circuit 132 can be prevented from being abraded and impacted by other objects in a mounting process.

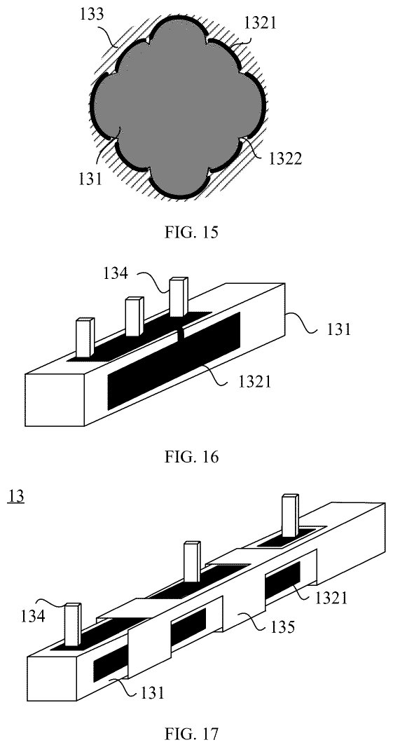

For example, based on the support frame 131 shown in FIG. 13, as shown in FIG. 15, the insulation medium 133 is filled outside the support frame 131, so that the external shape of the feed network 13 is a cylinder.

In an embodiment, the insulation medium may be plastic, rubber, or the like. This is not limited in this application.

In an example, the feed network 13 further includes a plurality of connection ports 134, and the plurality of connection ports 134 are deployed on the support frame 131. The plurality of connection ports 134 include a port (which may also be referred to as an input port of the feed network 13) configured to connect an input end of the signal transmission circuit 132 to the signal processing unit 5, and at least two ports (which may also be referred to as output ports of the feed network 13) that are configured to separately connect an output end of the signal transmission circuit 132 to each radiating element 121 in the antenna array corresponding to the feed network 13. The plurality of connection ports 134 may be deployed on a same surface of the support frame 131, or may be located on different surfaces.

For example, based on the structure shown in FIG. 4, as shown in FIG. 16, the feed network 13 may include three connection ports 134. One connection port 134 is connected to the signal processing unit 5 and is used as the input port of the feed network 13, and the other two connection ports 134 are respectively connected to the radiating elements 121 and are used as the output ports of the feed network 13. The three connection ports 134 are disposed on a same surface of the support frame 131.

In an example, if the signal transmission circuit 132 includes a phase shift circuit, that is, the feed network 13 has an electrical downtilt adjustment function, the feed network 13 may further include a phase shift medium 135. The phase shift medium 135 may move relative to the signal transmission circuit 132 under control of the phase shift circuit, to adjust a phase of the radiating element 121 connected to the output port of the signal transmission circuit 132.

In this embodiment of this application, based on the form of the support frame 131, the phase shift medium 135 may also be designed as a corresponding three-dimensional structure, to cover the signal transmission circuit 132. For example, based on the structure shown in FIG. 16, the structure of the phase shift medium 135 may be shown in FIG. 17.

### EMBODIMENT 2

The support frame 131 is of a hollow structure. The hollow structure includes a plurality of surfaces, the plurality of surfaces include at least one outer surface and at least one inner surface, and the plurality of surfaces may be all planes, may be all curved surfaces, or some surfaces may be planes and other surfaces may be curved surfaces. The plurality of functional units 1321 may be deployed on the inner surface and/or the outer surface of the support frame 131. When the plurality of functional units 1321 are deployed on the inner surface and the outer surface of the support frame 131, the functional unit 1321 deployed on the inner surface and the functional unit 1321 deployed on the outer surface may be directly connected, coupled, or not connected.

For example, a plated through hole may be disposed on a side wall of the hollow structure, to directly connect the functional unit 1321 deployed on the inner surface to the functional unit 1321 deployed on the outer surface. Alternatively, a hollow structure may be disposed on the side wall of the hollow structure, and the transit network 1322 is deployed by using the hollow structure, to directly connect the functional unit 1321 deployed on the inner surface to the functional unit 1321 deployed on the outer surface.

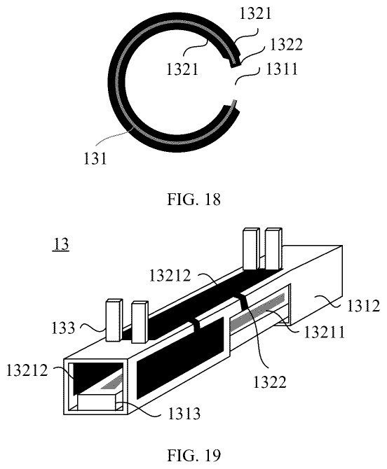

In an example, as shown in FIG. 18, the support frame 131 is a cylindrical structure with openings at two ends, and a through hole 1311 is disposed on the side wall of the support frame 131. The signal transmission circuit 132 includes two functional units 1321, which are respectively deployed on the inner surface and the outer surface of the support frame 131, and the transit network 1322 passes through the through hole 1311 to connect the two functional units 1321.

In an example, as shown in FIG. 19, the support frame 131 may further include a peripheral frame 1312 and a movable member 1313. The peripheral frame 1312 may be a hollow structure with a hollow side wall. The movable member 1313 may be located in a cavity of the peripheral frame 1312, and the movable member 1313 may move in the cavity.

In this example, the plurality of functional units 1321 may include a first transmission unit 13211 and a second transmission unit 13212. The first transmission unit 13211 is configured to connect to the signal processing unit 5 via the connection port 134, the second transmission unit 13212 is configured to connect to the plurality of radiating elements 121 via the connection port 134, and the first transmission unit 13211 is coupled to the second transmission unit 13212. The first transmission unit 13211 includes a phase shift circuit, and the second transmission unit 13212 includes a power division circuit.

The first transmission unit 13211 may be deployed on a surface of the movable member 1313, and the second transmission unit 13212 may be deployed on an inner surface and/or an outer surface of the peripheral frame 1312. As shown in FIG. 19, the second transmission units 13212 are deployed on the inner surface and the outer surface of the peripheral frame 1312, and the transit network 1322 passes through the hollow structure on the peripheral frame 1312 to directly connect the second transmission units 13212 deployed on the inner surface and the outer surface.

When the first transmission unit 13211 moves based on the movable member 1313 and moves relative to the second transmission unit 13212, a phase of each radiating element 121 connected to the second transmission unit 13212 can be adjusted.

In an example, when the second transmission unit 13212 uses a CPW transmission line structure, the first transmission unit 13211 may include a grounding plane covering the inner surface and/or the outer surface of the peripheral frame 1312, and a conducting wire is disposed on the grounding plane. The grounding plane may be deployed on the peripheral frame 1312 through electroplating and coating. The conducting wire and the grounding plane form the CPW transmission line structure. A circuit that can implement a corresponding function (for example, power division) is formed through a wiring design of the conducting wire.

The structures listed in Embodiment 1 and Embodiment 2 are merely example structures. The support frame 131 may alternatively be designed in another solid or hollow shape, so that the signal transmission circuit 132 presents the three-dimensional structure instead of the planar structure in space. This is not limited in this application.

In conclusion, the feed network 13 provided in this application uses the three-dimensional layout. This makes the structure of the feed network 13 more compact, can fully use the three-dimensional space, greatly improves the space utilization, and facilitates the miniaturization development of the feed network 13.

Based on the feed network provided in embodiments of this application, an embodiment of this application further provides an antenna device, including the feed network 13 provided in embodiments of this application.

The antenna device may be any antenna device having a radio frequency function, for example, a base station antenna, a vehicle-mounted antenna, or a satellite antenna.

The feed network is laid out in a three-dimensional manner, so that the space usage of the feed network is greatly improved, and the space occupied by the feed network in the antenna device is reduced. Therefore, this facilitates the miniaturization development of the antenna device.

In the foregoing embodiments, descriptions of each embodiment have respective focuses. For a part that is not described in detail or recorded in an embodiment, refer to related descriptions in another embodiment. In addition, the embodiments described above with reference to the accompanying drawings are examples, and are merely used to explain this application, but should not be understood as a limitation on this application.

It should be understood that, in the descriptions of the specification and the appended claims in this application, terms “include”, “have”, and any variants thereof are intended to cover non-exclusive inclusion. For example, a process, method, system, product, or device that includes a series of steps or modules is not necessarily limited to those clearly listed steps or modules, and may include other steps or modules that are not clearly listed or are inherent to the process, method, product, or device.

In descriptions of this application, unless otherwise specified, a character “/” indicates an “or” relationship between associated objects. For example, A/B may indicate A or B. In this application, a term “and/or” describes only an association relationship between the associated objects and indicates that three relationships may exist. For example, A and/or B may indicate three cases: Only A exists, both A and B exist, and only B exists, where A and B may be singular or plural.

In addition, in the descriptions of this application, “a plurality of” means two or more unless otherwise specified. “At least one of the following items” or a similar expression thereof means any combination of these items, including a single item or any combination of a plurality of items. For example, at least one of a, b, or c may indicate a, b, c, a and b, a and c, b and c, or a and b and c. Herein, a, b, and c may be singular or plural.

In addition, in the descriptions of the specification and the appended claims in this application, terms “first”, “second”, “third”, and the like are intended to distinguish between similar objects but do not necessarily indicate a particular order or sequence. It should be understood that data termed in such a way are interchangeable in proper circumstances, so that embodiments described herein can be implemented in other orders than the order illustrated or described herein.

Reference to “one embodiment” or “some embodiments” described in the specification of this application means that one or more embodiments of this application include a specific feature, structure, or characteristic described with reference to the embodiment. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner.

In the descriptions of this application, it should be noted that, unless otherwise specified and limited, terms “mounting”, and “connection” should be understood in a broad sense. For example, a connection may be a fastened connection, a detachable connection, or an integrated connection. Alternatively, a connection may be a mechanical connection or an electrical connection, or may mean mutual communication. Alternatively, a connection may be a direct connection, or an indirect connection through an intermediate medium, or may be a connection between two elements or an interaction relationship between two elements. A person of ordinary skill in the art may understand specific meanings of the foregoing terms in this application based on specific cases.

In the descriptions of this application, it should be understood that orientation or position relationships indicated by terms such as “upper”, “lower”, “side”, “front”, and “rear” are based on orientation or position relationships of mounting, and are used only for ease and brevity of illustration and description of this application, rather than indicating or implying that the mentioned apparatus or element needs to have a particular orientation or needs to be constructed and operated in a particular orientation. Therefore, such terms should not be understood as a limitation on this application.

It should be further noted that in embodiments of this application, a same reference numeral indicates a same component or a same part. For same parts in embodiments of this application, only one part or component marked with a reference numeral may be used as an example in the figure. It should be understood that the reference numeral is also applicable to another same part or component.

Finally, it should be noted that the foregoing embodiments are merely intended for describing the technical solutions of this application other than limiting this application. Although this application is described in detail with reference to the foregoing embodiments, a person of ordinary skill in the art should understand that modifications may still be made to the technical solutions described in the foregoing embodiments or equivalent replacements may be made to some or all technical features thereof, without departing from the scope of the technical solutions of embodiments of this application.

1. A feed network, comprising:
a support frame; and
a signal transmission circuit deployed on the support frame, wherein the signal transmission circuit comprises a plurality of functional units that are interconnected and are not located on a same plane.

2. The feed network according to claim 1, wherein
the plurality of functional units are respectively deployed on a plurality of surfaces of the support frame; and
the plurality of surfaces are not coplanar.

3. The feed network according to claim 2, wherein the plurality of surfaces comprise at least one of a curved surface or a plane.

4. The feed network according to claim 2, wherein
the support frame is a hollow structure; and
the plurality of surfaces comprise at least one of an inner surface or an outer surface of the support frame.

5. The feed network according to claim 2, wherein the plurality of surfaces comprise at least two curved surfaces with different curvatures.

6. The feed network according to claim 2, wherein
the plurality of functional units comprise a first functional unit; and
the first functional unit is deployed on different surfaces in the plurality of surfaces.

7. The feed network according to claim 2, wherein
the plurality of functional units are connected via a transmission line; and
the transmission line is deployed on the support frame.

8. The feed network according to claim 2, wherein
the plurality of functional units are connected via a connector; and
the connector is deployed on the support frame.

9. The feed network according to claim 1, wherein the signal transmission circuit is deployed on one curved surface of the support frame.

10. The feed network according to claim 1, wherein the feed network further comprises:
a phase shift medium, wherein
the plurality of functional units comprise a phase shift circuit;
the phase shift medium covers the support frame; and
the phase shift medium is capable of moving relative to the support frame under control of the phase shift circuit.

11. The feed network according to claim 1, wherein the support frame comprises:
a peripheral frame; and
a movable member, wherein
the movable member is located in a cavity of the peripheral frame; and
the movable member is capable of moving in the cavity;
the plurality of functional units comprise a first transmission unit and a second transmission unit;
the first transmission unit is deployed on at least one of an inner surface or an outer surface of the peripheral frame; and
the second transmission unit is disposed on a surface of the movable member.

12. The feed network according to claim 11, wherein the feed network further comprises:
a plurality of connection ports, wherein
the plurality of connection ports are configured to separately connect the signal transmission circuit to a radiating element and a signal processing unit;
the plurality of connection ports are deployed on the support frame; and
the plurality of connection ports are not located on a same plane or are located on a same plane.

13. An antenna device, comprising:
a feed network, comprising:
a support frame; and
a signal transmission circuit deployed on the support frame, wherein
the signal transmission circuit comprises a plurality of functional units that are interconnected and are not located on a same plane.

14. The antenna device, according to claim 13, wherein
the plurality of functional units are respectively deployed on a plurality of surfaces of the support frame; and
the plurality of surfaces are not coplanar.

15. The antenna device, according to claim 14, wherein the plurality of surfaces comprise at least one of a curved surface or a plane.

16. The antenna device, according to claim 14, wherein
the support frame is a hollow structure, and
the plurality of surfaces comprise at least one of an inner surface or an outer surface of the support frame.

17. The antenna device, according to claim 14, wherein the plurality of surfaces comprise at least two curved surfaces with different curvatures.

18. The antenna device, according to claim 14, wherein
the plurality of functional units comprise a first functional unit; and
the first functional unit is deployed on different surfaces in the plurality of surfaces.

19. The antenna device, according to claim 14, wherein
the plurality of functional units are connected via a transmission line; and
the transmission line is deployed on the support frame.

20. The antenna device, according to claim 14, wherein
the plurality of functional units are connected via a connector; and
the connector is deployed on the support frame.
